(19) United States
(12) Patent Application Publication
(10) Pub. No.: US 2023/0303431 A1
(43) Pub. Date: Sep. 28, 2023

(54) METHOD OF MANUFACTURING REINFORCED COVER WINDOW AND REINFORCED COVER WINDOW MANUFACTURED THEREBY

(71) Applicant: UTI INC., Yesan-gun (KR)

(72) Inventors: Kukhyun SUNWOO, Yesan-gun (KR); Hak Chul KIM, Yesan-gun (KR); Hee Jun AHN, Yesan-gun (KR); Joo Seok LEE, Yesan-gun (KR); Min Gyou SEO, Yesan-gun (KR)

(73) Assignee: UTI INC., Yesan-gun (KR)

(21) Appl. No.: 18/119,407

(22) Filed: Mar. 9, 2023

(30) Foreign Application Priority Data
Mar. 24, 2022 (KR) 10-2022-0036453

(51) Int. Cl. C03C 17/32; G02B 1/14; G02B 1/18; C03C 23/00

(52) U.S. Cl. CPC C03C 17/32; G02B 1/14; G02B 1/18; C03C 23/007; G06F 1/1652

(57) ABSTRACT

A method of manufacturing a reinforced cover window and a reinforced cover window manufactured thereby are proposed. The method includes a first step of forming a TPI layer on a base substrate, a second step of separating the TPI layer from the base substrate, a third step of forming an adhesive buffer layer on a glass substrate, and a fourth step of stacking the TPI layer on the adhesive buffer layer. This secures the TPI's unique pencil hardness of 4H to 6H while maintaining the unique aesthetic sense and touch feeling of the glass.

### CROSS REFERENCE TO RELATED APPLICATION

The present application claims priority to Korean Patent Application No. 10-2022-0036453, filed Mar. 24, 2022, the entire contents of which are incorporated herein for all purposes by this reference.

### BACKGROUND OF THE INVENTION

### Field of the Invention

The present disclosure relates to a cover window. More particularly, the present disclosure relates to a reinforced cover window in which a thin TPI layer is formed on a base substrate, is separated, and then is laminated on a glass substrate, so that the glass substrate and the TPI layer are implemented in a complex way.

### DESCRIPTION OF THE RELATED ART

Recently, electrical and electronic technologies are developing rapidly, and various types of display products are emerging to meet the new needs of the times and the demands of various consumers. Among them, research on a flexible display that may fold and unfold a screen is actively being conducted.

In the case of the flexible display, research on the form of bending, rolling, and stretching, starting from a folding form, is being conducted. In addition to a display panel, a cover window for protecting the display panel should also be flexibly formed.

Such a flexible cover window should basically have good flexibility, should not have marks on a folding portion even when repeatedly folded, and thereby should not cause distortion of picture quality.

An existing flexible cover window has used a polymer film on the surface of the display panel.

However, the polymer film has drawbacks in that it merely serves to prevent scratches on the display panel due to its weak mechanical strength, is vulnerable to impacts, has low transmittance, and is relatively expensive.

Further, such a polymer film is problematic in that, as the number of times of folding of the display increases, a delamination or buckling phenomenon in which marks are left in the folding portion frequently occurs.

Recently, various studies on a glass-based cover window have been conducted so as to overcome the limitation of the cover window formed of the polymer film.

The glass-based cover window requires basic physical properties, such as no distortion of the screen and sufficient strength even with repetitive contact of a touch pen and under a certain pressure, while satisfying folding characteristics.

That is, since the glass should exceed a certain thickness to satisfy strength characteristics whereas the glass should have the certain thickness or less to satisfy folding characteristics, it is necessary to conduct research on an optimum cover window thickness and structure that satisfy both the strength characteristics and the folding characteristics and have no distortion of the screen.

Recently, research on the hybrid cover window using the advantages of the polymer film and the glass is being conducted.

That is, there is recently conducted research on the cover window in which the polymer film is laminated on one or both surfaces of the glass substrate, thus minimizing the delamination or buckling problem, maintaining the aesthetic sense inherent in glass, maintaining a thickness suitable for securing strength, and simultaneously satisfying folding characteristics.

Transparent Polyimide (TPI) is used as one of materials having relatively high transmittance and high strength among polymer films used in such a hybrid cover window. That is, the TPI film is stacked on one or both surfaces of the glass substrate, thus providing a cover window formed of a composite material including a polymer film/glass substrate.

In the case of the conventional commercially available TPI film, its thickness exceeds 50 μm. Thus, this impairs unique aesthetic sense and touch feeling of the glass when the TPI film is laminated on the glass substrate despite the advantages of the TPI film. As the thickness of the TPI film increases, the surface hardness is deteriorated.

In addition, the conventional TPI film is produced through a roll-to-roll process. However, due to the characteristics of the roll-to-roll process, the surface roughness and the uniformity of the thickness are low, resulting in a rainbow phenomenon on the surface of the TPI film.

Further, due to the properties of the roll-to-roll process, the frequency of wrinkles on the surface is high and the possibility of surface scratches is high, resulting in deterioration in quality when a functional layer is coated on the TPI film.

In particular, problems in the roll-to-roll process become more severe as the TPI film becomes thinner. When the TPI film is used as a component of the hybrid cover window, this causes serious product defects.

### SUMMARY OF THE INVENTION

Accordingly, the present disclosure has been made keeping in mind the above problems occurring in the related art, and an objective of the present disclosure is to provide a reinforced cover window in which a thin TPI layer is formed on a base substrate, is separated, and then is laminated on a glass substrate, so that the glass substrate and the TPI layer are implemented in a complex way.

In order to achieve the objective of the present disclosure, the present disclosure provides a method of manufacturing a reinforced cover window, the method including a first step of forming a Transparent Polyimide (TPI) layer on a base substrate, a second step of separating the TPI layer from the base substrate, a third step of forming an adhesive buffer layer on a glass substrate, and a fourth step of stacking the TPI layer on the adhesive buffer layer.

Further, the TPI layer may be formed to have a thickness of 1 to 50 μm.

Further, the TPI layer in the first step may be coated on the base substrate by any one coating method among bar coating, slot die coating, and dip coating.

Further, the TPI layer in the first step may be formed by coating the TPI layer on the base substrate and curing the TPI layer, and may be cured through thermal curing or photocuring.

Further, the thermal curing of the TPI layer may be performed through a secondary curing process at 150 to 300° C. for 1 to 30 minutes after a primary curing process at 100 to 150° C. for 1 to 20 minutes.

Further, the adhesive buffer layer may be formed on a front surface of the glass substrate, or on each of front and back surfaces of the glass substrate, so that the TPI layer may be formed on the adhesive buffer layer

Further, the adhesive buffer layer may be formed on a side surface of the glass substrate

In the first step, the TPI layer may be formed, and a functional layer may be formed on the TPI layer. The functional layer may be a hard coating layer or an AF coating layer, or may be a layer obtained by sequentially forming the AF coating layer on the hard coating layer.

Further, the adhesive buffer layer may be formed of Optical Clear Resin (OCR), and a storage modulus of the OCR adhesive buffer layer may range from 0.01 Gpa to 1 Gpa.

Further, the separation of the TPI layer in the second step may be performed by a physical separation process, by a laser lift-off process, by release treatment of a surface of the base substrate, by forming a release layer on the base substrate, or using a difference in thermal expansion coefficient between the base substrate and the TPI layer.

Further, after the TPI layer is stacked on the adhesive buffer layer in the fourth step, the TPI layer, the adhesive buffer layer, and the glass substrate structure may be stacked on a carrier substrate, and a side of the structure may be vertically cut, thus separating the structure from the carrier substrate.

Further, a UV cut-off wavelength of the TPI layer may be 380 nm or less.

Further, the glass substrate may be formed such that a flat portion and a folding portion thereof have the same thickness or the folding portion is thinner than the flat portion, in the flexible cover window.

Further, the TPI layer may be formed such that the strength of the flat portion is equal to or different from that of the folding portion.

The present disclosure is to provide a hybrid cover window in which a glass substrate and a TPI layer are implemented in a complex way by a casting process where the thin TPI layer is formed on a base substrate, separated, and then laminated on the glass substrate.

Further, the present disclosure is to provide a reinforced cover window, which can form a TPI layer having a very thin thickness of 50 μm or less on a glass substrate by a process where the TPI layer is formed on a base substrate through coating, separated, and then laminated on the glass substrate, thus securing the TPI's unique pencil hardness of 4H to 6H while maintaining the unique aesthetic sense and touch feeling of the glass, and thereby having improved strength and strength properties.

Further, the present disclosure provides a high-quality hybrid cover window having excellent surface roughness of a TPI layer, uniform thickness, and excellent visibility by a process where the TPI layer is formed on a base substrate through coating, separated, and then laminated on a glass substrate.

### BRIEF DESCRIPTION OF THE DRAWINGS

FIG. 1 is a schematic view illustrating a method of manufacturing a reinforced cover window according to an embodiment of the present disclosure.

FIGS. 2 to 7 are schematic views illustrating reinforced cover windows according to various embodiments of the present disclosure.

### DETAILED DESCRIPTION OF THE INVENTION

The present disclosure is directed to a cover window, and a hybrid cover window in which a glass substrate and a transparent polyimide (TPI) layer are implemented in a complex way.

In particular, the present disclosure is to provide a hybrid cover window in which the glass substrate and the TPI layer are implemented in a complex way by a casting process where a thin TPI layer is formed on a base substrate, separated, and then laminated on the glass substrate.

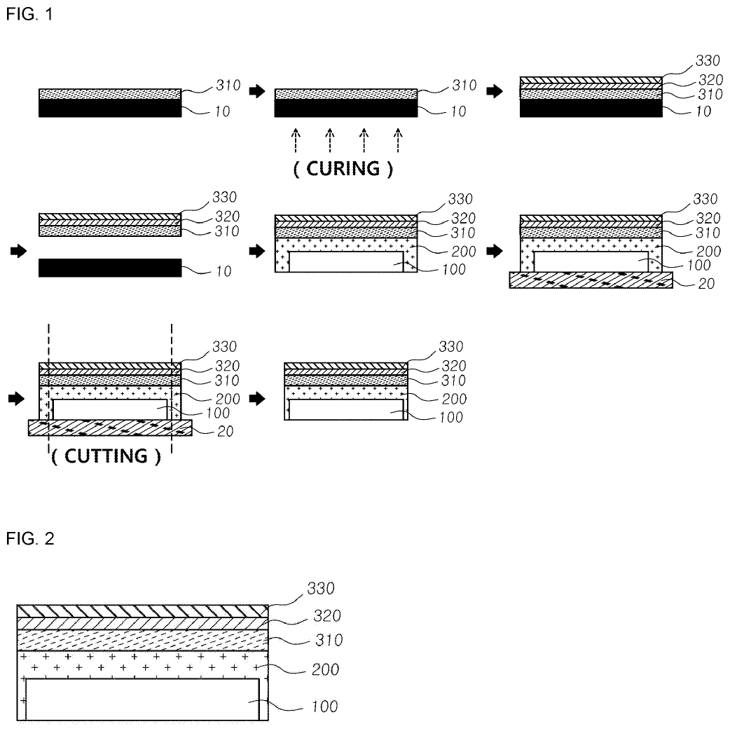

Hereinafter, the present disclosure will be described in detail with reference to the accompanying drawings. FIG. 1 is a schematic view illustrating a method of manufacturing a reinforced cover window according to an embodiment of the present disclosure, and FIGS. 2 to 7 are schematic views illustrating reinforced cover windows according to various embodiments of the present disclosure.

As shown in FIG. 1, a method of manufacturing a reinforced cover window according to the present disclosure includes a first step of forming a Transparent Polyimide (TPI) layer 310 on a base substrate 10, a second step of separating the TPI layer 310 from the base substrate 10, a third step of forming an adhesive buffer layer 200 on a glass substrate 100, and a fourth step of stacking the TPI layer 310 on the adhesive buffer layer 200.

The reinforced cover window according to the present disclosure manufactured by the above method includes a glass substrate 100, an adhesive buffer layer 200 formed on the glass substrate 100, and a TPI layer 310 formed on the adhesive buffer layer 200. After the TPI layer 310 is coated on the base substrate 10, it is separated from the base substrate 10 and formed on the adhesive buffer layer 200. The TPI layer 310 is formed to have the thickness of 1 to 50 μm.

According to the present disclosure, first, the TPI layer 310 is formed on the base substrate 10 (first step).

The base substrate 10 uses a flat plate that is thermally and chemically stable, and uses a material that has some rigidity to be supported when the TPI layer 310 is formed. As an embodiment of the present disclosure, glass may be used in consideration of transparency, durability, and economic efficiency, and films of a polymer material having some rigidity, such as polycarbonate, polyethylene terephthalate, acryl, polystyrene, or polymethyl methacrylate, may be used.

The TPI layer 310 is formed to a predetermined thickness on the base substrate 10. The TPI layer may be formed on the base substrate 10 by coating in various ways to have a uniform thickness and surface roughness.

In the present disclosure, the thickness of the TPI layer 310 is not limited to a specific thickness. If it is too thick, the unique texture or touch feeling of the glass substrate 100 used together is impaired, surface hardness is also lowered, and the thickness of the hybrid cover window becomes thicker. According to the present disclosure, the thickness is 50 μm or less, preferably 1 to 50 μm, more preferably 1 to 30 μm, and more preferably 10 to 25 μm.

By adjusting the thickness of the TPI layer 310, the unique texture and touch feeling of glass are maintained, and the hardness of the glass substrate 100 is followed due to the thin TPI layer 310, resulting in the surface hardness of 4H to 6H. Consequently, this provides a hybrid cover window that is thin as a whole and has improved strength. Such a thin hybrid cover window is suitable for application as a flexible cover window, and satisfies folding characteristics as well.

The TPI layer 310 is formed on the base substrate 10 by any one coating method including bar coating, slot die coating, and dip coating.

The TPI according to an embodiment of the present disclosure uses a method such as polymerization with anhydride or inclusion of fluorine in the polymer chain so as to reduce the charge transfer complex (CTC) of polyimide (PI). The TPI layer 310 formed in this way has high visible light transmittance and excellent optical transparency with the cutoff wavelength of 380 nm or less, more preferably 296 to 358 nm.

The TPI layer 310 according to the present disclosure is formed by coating the base substrate 10 with a coating solution containing 2 to 10 parts by weight of a primer on the basis of 100 parts by weight of TPI. That is, a solvent-free coating solution is used to prevent stains from occurring or prevent thickness uniformity from being deteriorated during curing.

This primer uses a silane coupling agent to enhance coupling to a TPI stock solution. For example, the silane coupling agent having a reactive group such as an ethoxy group, a methoxy group, a dialkoxy group, or a trialkoxy group may be used.

According to an embodiment of the present disclosure, the TPI layer 310 is coated on the base substrate 10, and the TPI layer 310 having the uniform thickness and excellent surface roughness is formed through thermal curing, photocuring by ultraviolet rays, or a combination thereof.

The thermal curing of the TPI layer 310 may be performed through a secondary curing process at 150 to 300° C. for 1 to 30 minutes after a primary curing process at 30 to 150° C. for 1 to 20 minutes.

Further, the photocuring of the TPI layer 310 is performed through primary curing by UV at 5 to 20 mW for 1 to 30 seconds, and secondary curing by UV at 150 to 500 mW for 1 to 5 seconds.

Further, the TPI layer 310 may be cured through secondary curing by UV at 150 to 500 mW for 1 to 5 seconds, after a primary drying process at 30 to 150° C. for 1 to 20 minutes.

The above-described primary curing process leads to the planarization of the TPI layer 310 and induces out gassing, and the secondary curing process causes the TPI layer 310 to be completely cured, thereby maintaining hardness.

On the other hand, a functional layer may be further formed on the TPI layer 310.

The functional layer may be formed in various ways depending on the use or purpose of the cover window. In the case of the cover window for protecting the display, the hard coating layer 320 or the AF coating layer 330 may be used, or the AF coating layer 330 may be sequentially formed on the hard coating layer 320.

The hard coating layer 320 may use resin having a relatively high hardness when cured, for example, resin having a high content of resin such as acryl or epoxy. If necessary, an anti-finger (AF) or anti-reflective (AR) function may be assigned. The hard coating layer may be made by synthesizing resin having such a function, or by forming various patterns on the functional layer.

Further, the TPI layer 310 is separated from the base substrate 10 (second step).

After the TPI layer 310 having uniform thickness and excellent surface roughness is coated on the base substrate 10, the TPI layer 310 is separated from the base substrate 10.

The separation of the TPI layer 310 may be performed by separating the TPI layer 310 from the base substrate 10 by a physical separation process, by a laser lift-off process, by release treatment of the surface of the base substrate 10, by forming a release layer on the substrate 10 or using a difference in thermal expansion coefficient between the base substrate 10 and the TPI layer 310.

In general, when glass is used as the base substrate 10, it is known that the TPI layer 310 coated on the glass does not have excellent coating properties. Thus, in the physical separation process of the TPI layer 310, the side portion of the TPI layer 310 may be lifted and separated from the base substrate 10 with a tool such as a knife.

Further, the laser lift-off process induces interface separation by a difference in laser absorptance. That is, when the energy of the laser is concentrated on the TPI layer 310, a bond between the base substrate 10 and the TPI layer 310 may be weakened by the thermal expansion of the base substrate (glass) 10 and the TPI layer 310 to separate the TPI from the base substrate 10.

Further, the release treatment, i.e. hydrophobic treatment (fluorine treatment) is performed on the surface of the base substrate 10 to facilitate the separation of the TPI layer 310, or the TPI is easily separated from the base substrate 10 by a method such as forming a release layer on the base substrate 10, i.e. forming a fluorine layer or coating a material having a difference in thermal expansion coefficient.

Further, the adhesive buffer layer 200 is formed on the glass substrate 100, and the TPI layer 310 separated from the base substrate 10 is stacked thereon (third and fourth steps).

That is, the present disclosure is to provide the hybrid cover window in which the glass substrate 100 and the TPI layer 310 are implemented in a complex way by the casting process where the TPI layer 310 is formed on the base substrate through coating, separated, and then laminated on the glass substrate 100 via the adhesive buffer layer 200.

The glass substrate 100 according to the present disclosure is chemically strengthened, and may be formed flat as a whole (a folding portion and a flat portion have the same thickness), or may be formed by slimming such that the folding portion is thinner in thickness than the flat portion, or may be formed as a two-piece or three-piece structure by segmenting the folding portion into one or more parts.

Generally, the thickness of the flat portion of the cover window is about to 300 μm, and the thickness of the folding portion is about 5 to 100 μm, when the folding portion is slimmed. Here, the thickness of the folding portion may be uniformly formed, or the thickness may gradually become thicker from the center of the folding area toward the outside thereof. That is, the folding portion may be formed in a straight or curved shape.

Further, in order to improve the strength and folding characteristics of the glass substrate 100, etching patterns may be formed on both the folding portion and the flat portion, or the folding portion.

The adhesive buffer layer 200 may be formed on the front surface of the glass substrate 100, or on each of the front and back surfaces of the glass substrate 100, so that the TPI layer 310 is formed on the adhesive buffer layer 200.

That is, the present disclosure implements the glass substrate 100 and the TPI layer 310 in a complex way. In particular, according to the present disclosure, the UV cut-off wavelength of the TPI layer 310 is formed to be 380 nm or less, so that the ultraviolet rays for curing the adhesive buffer layer 200 may be transmitted through the TPI layer 310. Thus, since the adhesive buffer layer 200 for bonding between the glass substrate 100 and the TPI layer 310 may be completely cured, adhesion between the glass substrate 100 and the TPI layer 310 is excellent, thereby improving overall durability. In this case, the adhesive buffer layer 200 according to present disclosure is formed of Optical Clear Resin (OCR).

Here, the front surface refers to a surface with which a user may touch, a surface with which a touch pen or the like contacts, or a surface oriented in an upward direction in the drawing. The back surface is a surface opposite to the front surface, refers to a surface opposite to the touch surface, i.e. a surface oriented toward the display panel, and means a surface oriented in a downward direction in the drawing.

The adhesive buffer layer 200 according to the present disclosure is formed of Optical Clear Resin (OCR) or Optical Clear Adhesion (OCA), and is coated on the glass substrate 100 to the thickness of about 1 to 75 μm. The adhesive buffer layer 200 basically combines the glass substrate 100 and the TPI layer 310 while maintaining appropriate thickness and elasticity to minimize deformation in the folding portion by the adhesive buffer layer 200, thereby further improving impact resistance and durability.

The adhesive buffer layer 200 may be formed between the glass substrate 100 and the TPI layer 310, or may be formed between the glass substrate 100 and the TPI layer 310 and then continuously formed on the side surface of the glass substrate 100. That is, the adhesive buffer layer 200 may be formed by wrapping the entire area of the glass substrate 100. Thus, it is possible to protect the side surface as well as the front or back surface of the glass substrate 100.

The adhesive buffer layer 200 may use transparent resin that is almost equal in refractive index (1.5) to glass, for example, acryl, epoxy, silicone, urethane, a urethane compound, a urethane acrylic compound, hybrid sol-gel, siloxane, etc. This is formed by selecting curing conditions or materials to adjust the hardness of the adhesive buffer layer 200.

The storage modulus of the OCR adhesive buffer layer 200 preferably ranges from 0.01 Gpa to 1 Gpa. Thus, by applying OCR, having a higher hardness than the existing OCA, to the adhesive buffer layer 200, the surface hardness is further increased, and adhesion to the glass substrate 100 is excellent, thereby improving overall durability and minimizing deformation at an interface even against impacts such as pen drops.

The adhesive buffer layer 200 according to the present disclosure is preferably completely cured for solid bonding between the glass substrate 100 and the TPI layer 310, but the adhesive buffer layer 200 may be partially cured if necessary. That is, a softer adhesive buffer layer 200 may be implemented to mitigate or absorb shock caused by deformation in the folding portion. This can be applied by adjusting a curing degree according to product specifications or materials.

If necessary, the adhesive buffer layer 200 may be relatively partially cured in the folding portion compared to the flat portion. That is, soft curing can be realized in the folding portion and complete curing can be realized in the flat portion. This can be realized by adjusting the intensity of ultraviolet rays using a mask or the like through the TPI layer 310 according to the present disclosure.

According to an embodiment of the present disclosure, the complete curing of the adhesive buffer layer 200 may be achieved by emitting ultraviolet rays at 150 to 600 mW for 1 to 10 seconds, and the partial curing (soft curing) may be achieved by emitting ultraviolet rays at 5 to 30 mW for 1 to 40 seconds.

Thus, the present disclosure may form the TPI layer 310 having a very thin thickness of 50 μm or less on the glass substrate 100 by the process where the TPI layer 310 is formed on the base substrate 10 through coating, separated, and then laminated on the glass substrate 100, thus securing the TPI's unique pencil hardness of 4H to 6H by following the surface hardness of the glass substrate 100 while maintaining the unique aesthetic sense and touch feeling of the glass.

Further, the present disclosure provides a high-quality hybrid cover window having the excellent surface roughness of the TPI layer 310, uniform thickness, and excellent visibility by the process where the TPI layer 310 is formed on the base substrate 10 through coating, separated, and then laminated on the glass substrate 100.

Further, when one desires to apply the reinforced cover window according to the present disclosure to the flexible cover window, the TPI layer 310 may be formed such that the strength of the flat portion is equal to or different from that of the folding portion.

For instance, the TPI layer 310 according to the present disclosure may be implemented to have a soft strength, thus mitigating or absorbing shock caused by deformation in the folding portion. This can be applied by adjusting a curing degree according to product specifications or materials.

If necessary, the TPI layer 310 may be relatively partially cured in the folding portion compared to the flat portion. That is, soft curing can be realized in the folding portion and complete curing can be realized in the flat portion. This can be realized by adjusting the above-described curing conditions.

Further, after the TPI layer 310 is stacked on the adhesive buffer layer 200 of the fourth step, the TPI layer 310, the adhesive buffer layer 200, and the glass substrate 100 are stacked on the carrier substrate 20, and the side of the structure is trimmed by cutting the side of the structure in a direction perpendicular to the carrier substrate 20 or to the glass substrate 100. A laser is used as a means for cutting the side of the structure.

Further, by separating the structure from the carrier substrate 20, a reinforced cover window structure according to the present disclosure is provided.

Therefore, the present disclosure may be used as a cover window for surface protection, touch panel protection, and display protection of various electronic products, or used as a cover window for protecting various types of flexible display panels such as foldable, rollable, slidable, and stretchable panels, and is stacked and laminated on the front surface of the flexible display panel.

A protective film may be formed on the outermost layer of the reinforced cover window according to the present disclosure. That is, when the TPI layer 310 is formed on the front surface or the front and back surfaces of the glass substrate 100, the protective film such as PET may be formed on the outermost layer of the structure to protect the structure. When a user intends to apply the reinforced cover window according to the present disclosure to the display panel, it is used after removing the protective film.

Hereinafter, various embodiments of the present disclosure will be described with reference to the accompanying drawings. The duplicated description will be omitted.

### First Embodiment

FIG. 2 illustrates the first embodiment of the present disclosure. As shown in the drawing, the adhesive buffer layer 200 is formed on the front surface of the glass substrate 100, and the TPI layer 310, the hard coating layer 320, and the AF coating layer 330 are sequentially formed on the adhesive buffer layer.

After the TPI layer 310 is coated and cured on the base substrate 10 and the hard coating layer 320 and the AF coating layer 330 are formed on the TPI layer, the TPI layer/hard coating layer/AF coating layer are separated from the base substrate 10.

Further, the adhesive buffer layer 200 is formed on the front and side surfaces of the glass substrate 100, and the TPI layer/hard coating layer/AF coating layer are stacked and laminated thereon, thereby providing the hybrid reinforced cover window having the glass substrate 100 and the TPI layer 310.

The TPI layer 310 having uniform thickness and surface roughness is formed on the base substrate 10. By the casing process where the TPI layer 310 is laminated on the glass substrate 100, the TPI layer 310 having a very thin thickness is formed, thus securing the TPI's unique pencil hardness of 4H to 6H while maintaining the unique aesthetic sense and touch feeling of the glass.

### Second Embodiment

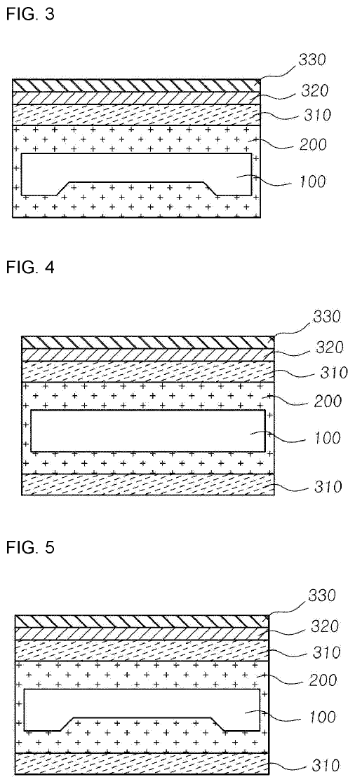

FIG. 3 illustrates the second embodiment of the present disclosure. Unlike the first embodiment, the folding portion of the glass substrate 100 is formed to be slim. In this case, all of the front surface, back surface, and side surface of the glass substrate 100 are wrapped by the adhesive buffer layer 200.

The second embodiment of the present disclosure may be used as the cover window for protecting the flexible display.

### Third Embodiment

FIG. 4 illustrates the third embodiment of the present disclosure. The adhesive buffer layer 200 is formed on the front surface, back surface, and side surface of the glass substrate 100, and the TPI layer 310, the hard coating layer 320, and the AF coating layer 330 are sequentially formed on the front surface of the glass substrate 100, and the TPI layer 310 is formed on the back surface of the glass substrate.

After the TPI layer 310 is coated and cured on the base substrate 10 and the hard coating layer 320 and the AF coating layer 330 are formed on the TPI layer, the TPI layer/hard coating layer/AF coating layer are separated from the base substrate 10.

Further, the adhesive buffer layer 200 is formed on the front and side surfaces of the glass substrate 100, and the TPI layer/hard coating layer/AF coating layer are stacked and laminated thereon. Next, the adhesive buffer layer 200 is formed on the back surface of the glass substrate, and the TPI layer 310 is formed on the adhesive buffer layer, thus providing the hybrid reinforced cover window formed of a composite material.

The TPI layer 310 having a very thin thickness is formed by the casting process where the TPI layer 310 having uniform thickness and surface roughness is formed on the base substrate 10 and then laminated on the glass substrate, thus securing the TPI's unique pencil hardness of 4H to 6H while maintaining the unique aesthetic sense and touch feeling of the glass.

### Fourth Embodiment

FIG. 5 illustrates the fourth embodiment of the present disclosure. Unlike the third embodiment, the folding portion of the glass substrate is formed to be slim. The fourth embodiment of the present disclosure may be used as the cover window for protecting the flexible display.

### Fifth Embodiment

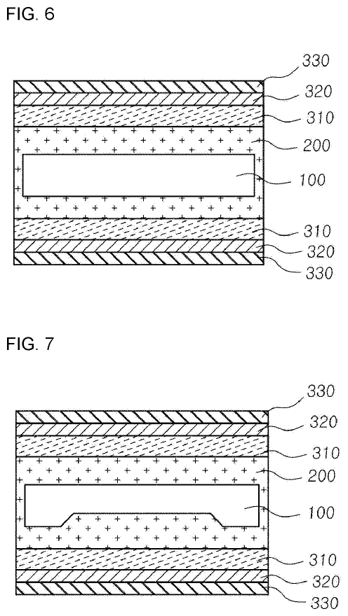

FIG. 6 illustrates the fifth embodiment of the present disclosure. The adhesive buffer layer 200 is formed on the front surface, back surface, and side surface of the glass substrate, and the TPI layer 310, the hard coating layer 320, and the AF coating layer 330 are sequentially formed on the front surface of the glass substrate, and a symmetrical structure is also formed on the back surface of the glass substrate.

After the TPI layer 310 is coated and cured on the base substrate 10 and the hard coating layer 320 and the AF coating layer 330 are formed on the TPI layer, the TPI layer/hard coating layer/AF coating layer are separated from the base substrate 10.

Further, the adhesive buffer layer 200 is formed on the front and side surfaces of the glass substrate 100, and the TPI layer/hard coating layer/AF coating layer are stacked and laminated thereon. Next, the adhesive buffer layer 200 is formed on the back surface of the glass substrate, and the TPI layer/hard coating layer/AF coating layer are stacked and laminated on the adhesive buffer layer, thus providing the hybrid reinforced cover window formed of a composite material.

The TPI layer 310 having a very thin thickness is formed by the casting process where the TPI layer 310 having uniform thickness and surface roughness is formed on the base substrate 10 and then laminated on the glass substrate, thus securing the TPI's unique pencil hardness of 4H to 6H while maintaining the unique aesthetic sense and touch feeling of the glass.

### Sixth Embodiment

FIG. 7 illustrates the sixth embodiment of the present disclosure. Unlike the fifth embodiment, the folding portion of the glass substrate is formed to be slim. The sixth embodiment of the present disclosure may be used as the cover window for protecting the flexible display.

Table 1 shows pen drop characteristics and hardness measurement data on the reinforced cover windows according to the first to sixth embodiment of the present disclosure and comparative examples.

TABLE 1

| | | Hardness |
|---|---|---|
| | Pen drop | Measurement |
| | characteristics | (Hardness) |
| Comparative Example 1 | 2 cm to 3 cm | 4H |
| (Bare) | | |
| Comparative Example 2 | 4 cm to 5 cm | 3H |
| Comparative Example 3 | 8 cm | B |
| Comparative Example 4 | 10 cm | H |
| First Embodiment | 10 cm or more | 6H |
| Second Embodiment | 10 cm or more | 5H |
| Third Embodiment | 10 cm or more | 6H |
| Fourth Embodiment | 10 cm or more | 5H |
| Fifth embodiment | 10 cm or more | 6H |
| Sixth embodiment | 10 cm or more | 6H |

Comparative example 1 shows the glass substrate (Bare) having the thickness of 50 μm, comparative example 2 shows a case where the hard coating layer having the thickness of 2 μm is formed on the glass substrate having the thickness of 50 μm, comparative example 3 shows a case where the TPI film having the thickness of 60 μm is formed on the glass substrate having the thickness of 50 μm, and comparative example 4 shows a case where the TPI film having the thickness of 60 μm is formed on the glass substrate having the thickness of 50 μm and then the hard coating layer having the thickness of about 2 μm is formed thereon.

The first to sixth embodiments are formed to have the above-described structure, and show cases where the TPI layer having the thickness of 20 μm, the hard coating layer having the thickness of 2 μm, and the AF coating layer of nm are formed by bar coating on the glass substrate having the thickness of 50 μm, the adhesive buffer layer having the thickness of 5 μm, and the base substrate.

As shown in Table 1, it can be seen that the embodiment according to the present disclosure was significantly improved to 10 cm or more in pen drop characteristics, and was also improved to 5H or more in hardness.

As described above, the present disclosure provides a cover window, and a hybrid reinforced cover window in which a glass substrate and a TPI layer are implemented in a complex way.

In particular, the present disclosure is to provide a hybrid cover window in which a glass substrate and a TPI layer are implemented in a complex way by a casting process where the thin TPI layer is formed on a base substrate, separated, and then laminated on the glass substrate.

Further, the present disclosure can form a TPI layer having a very thin thickness of 50 μm or less on a glass substrate by a process where the TPI layer is formed on a base substrate through coating, separated, and then laminated on the glass substrate, thus securing the TPI's unique pencil hardness of 4H to 6H while maintaining the unique aesthetic sense and touch feeling of the glass.

Further, the present disclosure provides a high-quality hybrid cover window having excellent surface roughness of a TPI layer, uniform thickness, and excellent visibility by a process where the TPI layer is formed on a base substrate through coating, separated, and then laminated on a glass substrate.

Therefore, the present disclosure is improved in strength and surface properties to be used as a cover window for surface protection, touch panel protection, and display protection of various electronic products, or as a cover window for protecting various types of flexible display panels such as foldable, rollable, slidable, and stretchable panels.

What is claimed is:

1. A method of manufacturing a reinforced cover window, the method comprising:
a first step of forming a Transparent Polyimide (TPI) layer on a base substrate;
a second step of separating the TPI layer from the base substrate;
a third step of forming an adhesive buffer layer on a glass substrate; and
a fourth step of stacking the TPI layer on the adhesive buffer layer.

2. The method of claim 1, wherein the TPI layer is formed to have a thickness of 1 to 50 μm.

3. The method of claim 1, wherein the TPI layer in the first step is coated on the base substrate by any one coating method among bar coating, slot die coating, and dip coating.

4. The method of claim 1, wherein the TPI layer in the first step is formed by coating the TPI layer on the base substrate, and curing the TPI layer.

5. The method of claim 4, wherein the TPI layer is cured through thermal curing or photocuring.

6. The method of claim 5, wherein the thermal curing of the TPI layer is performed through a secondary curing process at 150 to 300° C. for 1 to 30 minutes after a primary curing process at 100 to 150° C. for 1 to 20 minutes.

7. The method of claim 1, wherein the adhesive buffer layer is formed on a front surface of the glass substrate, or on each of front and back surfaces of the glass substrate, so that the TPI layer is formed on the adhesive buffer layer

8. The method of claim 7, wherein the adhesive buffer layer is formed on a side surface of the glass substrate

9. The method of claim 7, wherein, in the first step, the TPI layer is formed, and a functional layer is formed on the TPI layer.

10. The method of claim 8, wherein the functional layer is a hard coating layer or an AF coating layer, or is a layer obtained by sequentially forming the AF coating layer on the hard coating layer.

11. The method of claim 1, wherein the adhesive buffer layer is formed of Optical Clear Resin (OCR).

12. The method of claim 11, wherein a storage modulus of the OCR adhesive buffer layer ranges from 0.01 Gpa to 1 Gpa.

13. The method of claim 1, wherein the separation of the TPI layer in the second step is performed by a physical separation process, by a laser lift-off process, by release treatment of a surface of the base substrate, by forming a release layer on the base substrate, or using a difference in thermal expansion coefficient between the base substrate and the TPI layer.

14. The method of claim 1, wherein, after the TPI layer is stacked on the adhesive buffer layer in the fourth step, the TPI layer, the adhesive buffer layer, and the glass substrate structure are stacked on a carrier substrate, and a side of the structure is vertically cut, thus separating the structure from the carrier substrate.

15. The method of claim 1, wherein a UV cut-off wavelength of the TPI layer is 380 nm or less.

16. The method of claim 1, wherein the glass substrate is formed such that a flat portion and a folding portion thereof have the same thickness or the folding portion is thinner than the flat portion, in the flexible cover window.

17. The method of claim 16, wherein the TPI layer is formed such that a strength of the flat portion is equal to or different from that of the folding portion.

18. A reinforced cover window comprising:
a glass substrate;
an adhesive buffer layer formed on the glass substrate; and
a TPI layer formed on the adhesive buffer layer,
wherein the TPI layer is coated on a base substrate, is separated from the base substrate, and is formed on the adhesive buffer layer,
wherein the TPI layer has a thickness of 1 to 50 μm.

19. The reinforced cover window of claim 18, wherein a folding portion of the glass substrate has a thickness of 5 to 100 μm, and a flat portion thereof has a thickness of 20 to 300 μm.

20. The reinforced cover window of claim 18, wherein the adhesive buffer layer is formed on a front surface of the glass substrate, or on each of front and back surfaces of the glass substrate, so that the TPI layer is formed on the adhesive buffer layer

21. The reinforced cover window of claim 18, wherein the adhesive buffer layer is formed on a side surface of the glass substrate

22. The reinforced cover window of claim 18, wherein a functional layer is formed on the TPI layer.

23. The reinforced cover window of claim 18, wherein the functional layer is a hard coating layer or an AF coating layer, or is a layer obtained by sequentially forming the AF coating layer on the hard coating layer.

24. The reinforced cover window of claim 18, wherein the adhesive buffer layer is formed of Optical Clear Resin (OCR).

25. The reinforced cover window of claim 24, wherein a storage modulus of the OCR adhesive buffer layer ranges from 0.01 Gpa to 1 Gpa.

26. The reinforced cover window of claim 18, wherein a UV cut-off wavelength of the TPI layer is 380 nm or less.

27. The reinforced cover window of claim 18, wherein the glass substrate is formed such that a flat portion and a folding portion thereof have the same thickness or the folding portion is thinner than the flat portion, in the flexible cover window.

28. The reinforced cover window of claim 27, wherein the TPI layer is formed such that a strength of the flat portion is equal to or different from that of the folding portion.

29. The reinforced cover window of claim 18, wherein a protective film is formed on an outermost layer of the reinforced cover window.
